(19) United States
(12) Patent Application Publication
(10) Pub. No.: US 2020/0143773 A1
(43) Pub. Date: May 7, 2020

(54) AUGMENTED REALITY IMMERSIVE READER

(71) Applicant: Microsoft Technology Licensing, LLC, Redmond, WA (US)

(72) Inventors: Michael Tholfsen, Seattle, WA (US); Ryan Waller, Redmond, WA (US); Paul Ronald Ray, Kirkland, WA (US)

(21) Appl. No.: 16/181,922

(22) Filed: Nov. 6, 2018

(51) Int. Cl. G09G 5/22; G06K 9/00; G06F 3/16; G06T 19/00; G06F 17/21; G10L 13/04

(52) U.S. Cl. CPC G09G 5/22; G06K 9/00671; G06F 3/167; G06K 2209/01; G06F 17/211; G10L 13/043; G06T 19/006

(57) ABSTRACT

A mobile device accesses an image generated with an image sensor of the mobile device. The mobile device detects text content in the image (using Optical Character Recognition). The mobile device accesses a reading preference of a user of the mobile device and formats the text content according to the reading preference. The mobile device then generates and displays the formatted text content in a display of the mobile device.

### BACKGROUND

### Technical Field

The subject matter disclosed herein generally relates to a special-purpose machine that converts an image of text content into a virtual object displayed based on reading preferences, including computerized variants of such special-purpose machines and improvements to such variants, and to the technologies by which such special-purpose machines become improved compared to other special-purpose machines that display text.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a network environment for operating a display device in accordance with one example embodiment.

FIG. 2 illustrates a display device in accordance with one example embodiment.

FIG. 3 illustrates a server in accordance with one example embodiment.

FIG. 4 illustrates a method for generating and displaying formatted text content in accordance with one example embodiment.

FIG. 5 illustrates a method for generating and displaying formatted text content in accordance with another example embodiment.

FIG. 6 illustrates an example screenshot of a display device in accordance with one embodiment.

FIG. 7 illustrates an example screenshot of a display device in accordance with one embodiment.

FIG. 8 illustrates an example screenshot of a display device in accordance with one embodiment.

FIG. 9 is block diagram showing a software architecture within which the present disclosure may be implemented, according to an example embodiment,

FIG. 10 is a diagrammatic representation of a machine in the form of a computer system within which a set of instructions may be executed for causing the machine to perform any one or more of the methodologies discussed herein, according to an example embodiment.

### DETAILED DESCRIPTION

### Glossary

“Component” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Communication Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology. General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Machine-Storage Medium” in this context refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Processor” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Carrier Signal” in this context refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Signal Medium” in this context refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Computer-Readable Medium” in this context refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

### Description

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Immersive reading refers to formatting text from a document in such a way that it provides the ability for a user with reading challenges (e.g., dyslexia, ADHD, or visual impairment) to help read. In one example, the user points his/her mobile device (e.g., smart phone, also referred to as “display device”) to a page of a book or a document. The mobile device converts (in real-time) the text in the page or the document to an immersive reader format (e.g., breaking text into syllables, reading the text out loud, increasing the spacing between lines and letters, and color coding words). In one example, the mobile device can be inserted in a head mounted adapter such as a headset to allow the user to view the immersive reading content (e.g., virtual content) in a virtual environment (Virtual Reality also referred to as “VR) or a mixed environment (Augmented Reality also referred to as “AR”). The mobile device in the headset blocks all outside stimulation (or distraction) to the user so that the user can focus on the reading experience. In one example, the immersive reading experience can be operated by the user via an inertial sensor (e.g., gyroscope, accelerometer) in the mobile device or via any other user interface (e.g., remote control, wireless mouse). Therefore, the present application describes the real-time conversion of text from a document to an immersive reading experience in a focused reading mode such as a VR environment (or AR environment).

In one example embodiment, a mobile device accesses an image generated with an image sensor of the mobile device. The mobile device detects text content in the image (using Optical Character Recognition process). The mobile device accesses a reading preference (e.g., increased line spacing, break words into syllables) and formats the text content according to the reading preference. The mobile device then generates and displays the formatted text content in a display of the mobile device.

As a result, one or more of the methodologies described herein facilitate solving the technical problem of formatting and displaying text in real time for a virtual environment. As such, one or more of the methodologies described herein may obviate a need for certain efforts or computing resources that otherwise would be involved in communicating an image of a document between different applications to identify text in the document, to determine a viewing format, and to convert the text to the viewing format. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

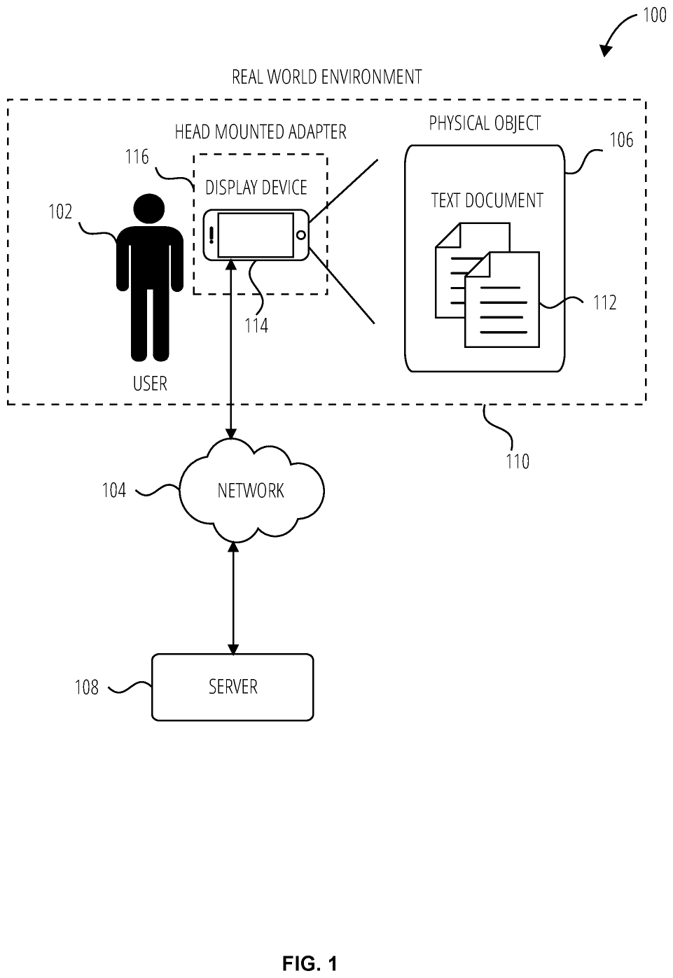

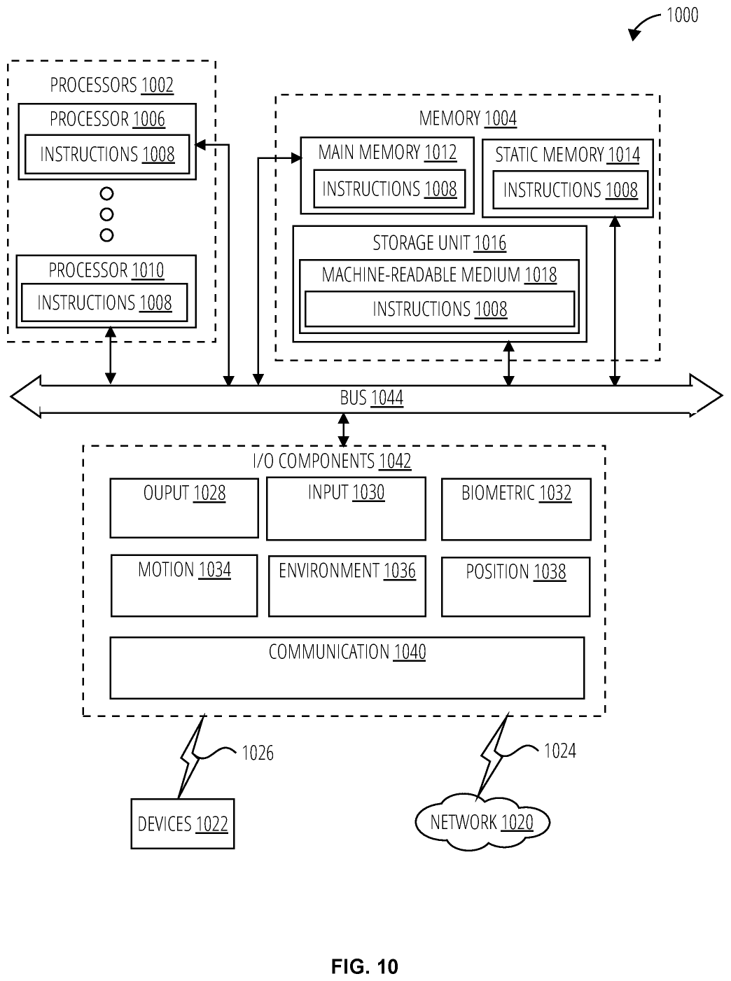

FIG. 1 is a network diagram illustrating a network environment 100 suitable for operating a display device 114, according to some example embodiments. The network environment 100 includes a display device 114 and a server 108, communicatively coupled to each other via a network 104. The display device 114 and the server 108 may each be implemented in a computer system, in whole or in part, as described below with respect to FIG. 10.

The server 108 may be part of a network-based system. For example, the network-based system may be or include a cloud-based server system that provides additional information, such as three-dimensional models of virtual objects, to the display device 114.

FIG. 1 illustrates a user 102 using the display device 114. The user 102 may be a human user (e.g., a human being), a machine user (e.g., a computer configured by a software program to interact with the display device 114), or any suitable combination thereof (e.g., a human assisted by a machine or a machine supervised by a human). The user 102 is not part of the network environment 100 but is associated with the display device 114 and may be a user 102 of the display device 114. The display device 114 may be a computing device with a display such as a smartphone, a tablet computer, or a wearable computing device (e.g., glasses). The computing device may be hand held or may be removable mounted (via a head mounted adapter 116) to a head of the user 102. The head mounted adapter 116 enables the user 102 to view a display of the display device 114 via a pair of lenses. In one example, the display of the display device 114 includes a screen that displays what is captured with a camera of the display device 114. In another example, the display of the display device 114 may be transparent such as in lenses of wearable computing glasses. In another example, the display may be non-transparent and wearable by the user 102 and covers the field of vision of the user 102.

The user 102 may be a user of an application in the display device 114. The application may include a AR/VR application configured to provide the user 102 with an experience triggered by a physical object 106, such as a two-dimensional physical object (e.g., a document), a three-dimensional physical object (e.g., a book), a location (e.g., at a work place of the user 102), or any references (e.g., perceived corners of walls or furniture) in the real-world physical environment. For example, the user 102 may point a camera of the display device 114 to capture an image of the physical object 106. For example, the physical object 106 includes a text document 112.

In one example embodiment, the display device 114 detects the text document 112 and converts the text document 112 into text content (for example, using an OCR application). The display device 114 accesses a reading preference of the user 102 at the display device 114 and formats the text content according to the reading preference. The display device 114 displays the formatted text content in a VR/AR environment to the user 102. For example, the display device 114 displays the formatted text content in a “focused” mode where nothing else displayed besides the formatted text content. In another example, the display device 114 displays the formatted text content as a virtual page overlaid on the text document 112. In other words, to the user 102, the text document 112 has been replaced with the formatted text content.

In another example embodiment, the image is tracked and recognized locally in the display device 114 using a local context recognition dataset module of the AR/VR application of the display device 114. For example, the local context recognition dataset module may include a library of virtual objects associated with real-world physical objects or references. The AR/VR application then generates additional information corresponding to the image (e.g., a three-dimensional model) and presents this additional information in a display of the display device 114 in response to identifying the recognized image. If the captured image is not recognized locally at the display device 114, the display device 114 downloads additional information (e.g., the three-dimensional model) corresponding to the captured image, from a database of the server 108 over the network 104.

The display device 114 tracks the pose (e.g., position and orientation) of the display device 114 relative to the real world environment 110 using optical sensors (e.g., depth-enabled 3D camera, image camera), inertia sensors (e.g., gyroscope, accelerometer), wireless sensors (Bluetooth, Wi-Fi), GPS sensor, and audio sensor to determine the location of the display device 114 within the real world environment 110.

The computing resources of the server 108 may be used to detect and identify the physical object 106 based on sensor data (e.g., image and depth data) from the display device 114, determine a pose of the display device 114 and the physical object 106 based on the sensor data. The server 108 can also generate a virtual object based on the pose of the display device 114 and the physical object 106. The server 108 communicate the virtual object to the display device 114. The object recognition, tracking, and AR rendering can be performed on either the display device 114, the server 108, or a combination between the display device 114 and the server 108.

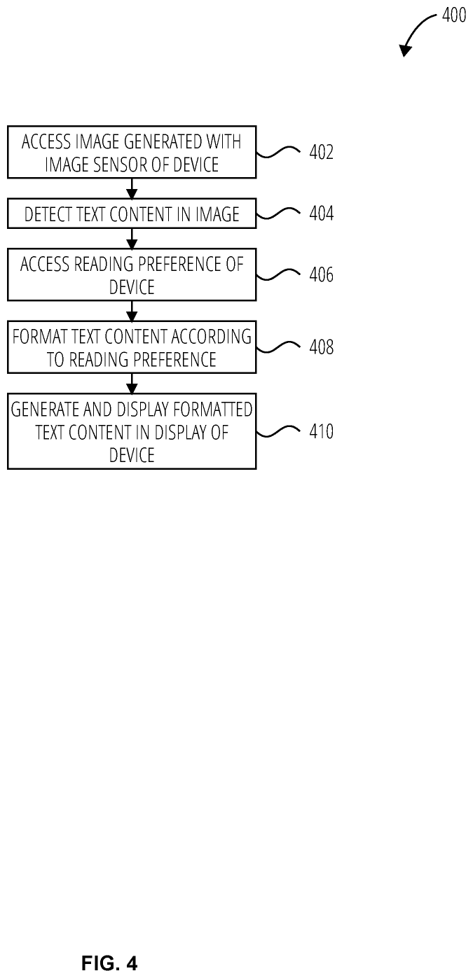

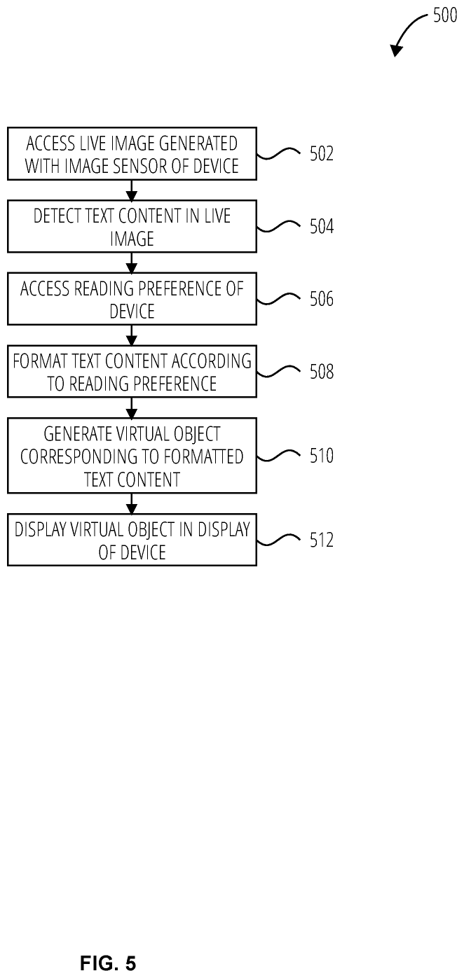

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 4 to FIG. 5. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 104 may be any network that enables communication between or among machines (e.g., server 108), databases, and devices (e.g., display device 114). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

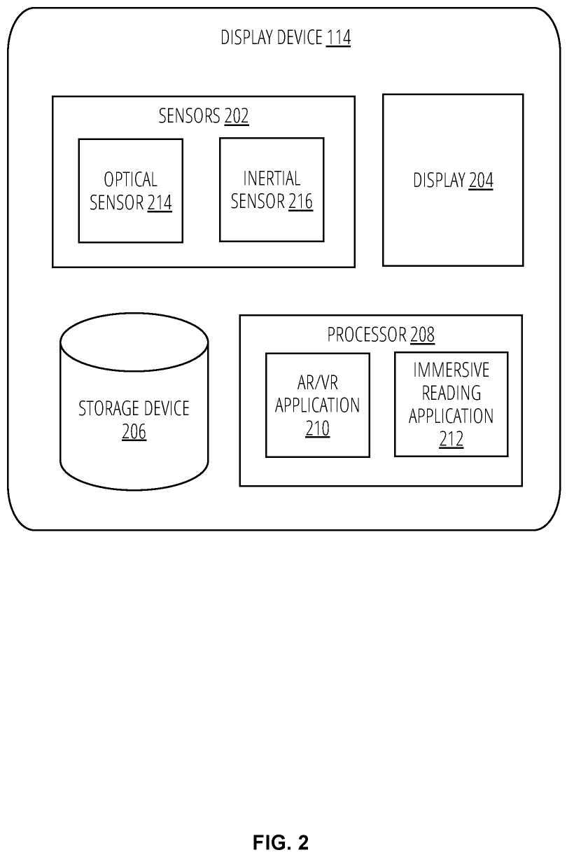

FIG. 2 is a block diagram illustrating modules (e.g., components) of the display device 114, according to some example embodiments. The display device 114 includes sensors 202, a display 204, a processor 208, and a storage device 206. The display device 114 may be, for example, a wearable computing device, desktop computer, a vehicle computer, a tablet computer, a navigational device, a portable media device, or a smart phone of the user 102.

The sensors 202 may include, for example, a proximity or location sensor (e.g., near field communication, GPS, Bluetooth, WIFI), an optical sensor 214 (e.g., camera such as a color camera, a thermal camera, a depth sensor and one or multiple grayscale, global shutter tracking cameras), an inertial sensor 216 (e.g., gyroscope, accelerometer), an audio sensor (e.g., a microphone), or any suitable combination thereof. The optical sensor 214 may include a rear-facing camera and a front-facing camera in the display device 114. It is noted that the sensors 202 described herein are for illustration purposes and the sensors 202 are thus not limited to the ones described.

The display 204 includes, for example, a touchscreen display configured to receive a user input via a contact on the touchscreen display. In one example embodiment, the display 204 includes a screen or monitor configured to display images generated by the processor 208. In another example embodiment, the display 204 may be transparent or semi-opaque so that the user 102 can see through the display 204 (e.g., Head-Up Display).

The processor 208 includes an AR/VR application 210 and an immersive reading application 212. The AR/VR application 210 detects and identifies the physical object 106 using computer vision. For example, the AR/VR application 210 detects the text document 112 from the physical object 106 using OCR and generates a virtual object based on the text document 112. In another example, the AR/VR application 210 retrieves a virtual object based on the identified physical object 106 and renders the virtual object in the display 204. The AR/VR application 210 includes a local rendering engine that generates a visualization of a three-dimensional virtual object overlaid on (e.g., superimposed upon, or otherwise displayed in tandem with) an image of the physical object 106 captured by the optical sensor 214. A visualization of the three-dimensional virtual object may be manipulated by adjusting a position of the physical object 106 (e.g., its physical location, orientation, or both) relative to the optical sensor 214. Similarly, the visualization of the three-dimensional virtual object may be manipulated by adjusting a pose of the display device 114 relative to the physical object 106.

In another example embodiment, the display device 114 includes a local image recognition module (not shown) configured to determine whether the captured image matches an image locally stored in a local database of images and corresponding additional information (e.g., three-dimensional model and interactive features) on the display device 114. In one example embodiment, the local image recognition module retrieves a primary content dataset from the server 108 and generates and updates a contextual content dataset based on an image captured with the display device 114.

The immersive reading application 212 formats the text from the text document 112 according to a reading preference of the user 102. The immersive reading application 212 then provides the formatted text content to the AR/VR application 210. The AR/VR application 210 displays a virtual object that includes the formatted text content in the display 204. In one example, the AR/VR application 210 displays the formatted text content in a VR immersive format (e.g., the display 204 only displays the formatted text content). In another example, the AR/VR application 210 displays the formatted text content in an AR immersive format (e.g., the display 204 displays the formatted text content with a live-image captured from the optical sensor 214). The AR/VR application 210 renders the formatted text content contained in the image of the text document 112. In another example, the AR/VR application 210 renders the formatted text content to appear on the physical object 106 (e.g., the size of the formatted text content matches the size of the physical object 106).

The storage device 206 stores the reading preference of the user 102. For example, the reading preference includes breaking text into syllables, reading the text out loud, increasing the spacing between lines and letters, and color coding words.

In another example embodiment, the storage device 206 may be configured to store a database of visual references (e.g., images) and corresponding experiences (e.g., three-dimensional virtual objects, interactive features of the three-dimensional virtual objects). In one example embodiment, the storage device 206 includes a primary content dataset, a contextual content dataset, and a visualization content dataset. The primary content dataset includes, for example, a first set of images and corresponding experiences (e.g., interaction with three-dimensional virtual object models). For example, an image may be associated with one or more virtual object models. The primary content dataset may include a core set of images of the most accessed images determined by the server 108. The core set of images may include a limited number of images identified by the server 108. For example, the core set of images may include the images depicting covers of the ten most viewed physical objects and their corresponding experiences (e.g., virtual objects that represent the ten most viewed physical objects). In another example, the server 108 may generate the first set of images based on the most popular or often scanned images received at the server 108. Thus, the primary content dataset does not depend on physical objects or images scanned by the display device 114.

The contextual content dataset includes, for example, a second set of images and corresponding experiences (e.g., three-dimensional virtual object models) retrieved from the server 108. For example, images captured with the display device 114 that are not recognized (e.g., by the server 108) in the primary content dataset are submitted to the server 108 for recognition. If the captured image is recognized by the server 108, a corresponding experience may be downloaded at the display device 114 and stored in the contextual content dataset. Thus, the contextual content dataset relies on the context in which the display device 114 has been used. As such, the contextual content dataset depends on objects or images scanned by display device 114.

In one example embodiment, the display device 114 may communicate over the network 104 with the server 108 to retrieve a portion of a database of visual references, corresponding three-dimensional virtual objects, and corresponding interactive features of the three-dimensional virtual objects.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

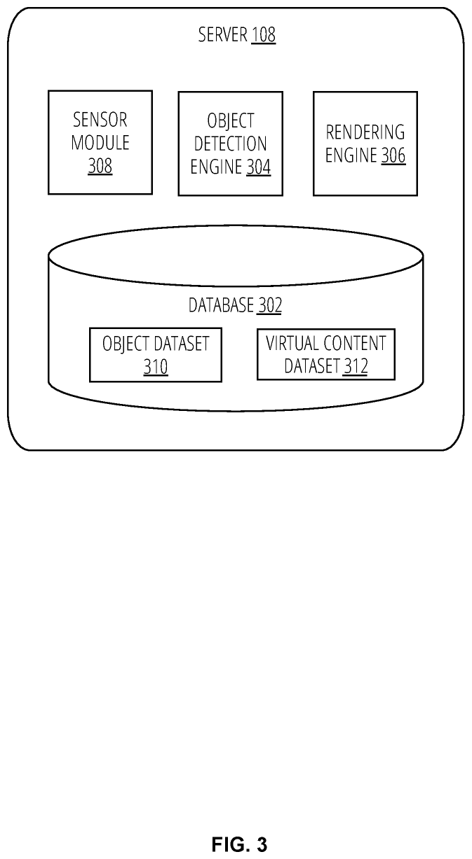

FIG. 3 is a block diagram illustrating modules (e.g., components) of the server 108. The server 108 includes a sensor module 308, an object detection engine 304, a rendering engine 306, and a database 302.

The sensor module 308 interfaces and communicates with sensors 202 to obtain sensor data related to a pose (e.g., location and orientation) of the display device 114 relative to a first frame of reference (e.g., the room or real-world environment 110) and to one or more objects (e.g., physical object 106).

The object detection engine 304 accesses the sensor data from sensor module 308, to detect and identify the physical object 106 based on the sensor data. The rendering engine 306 generates virtual content that is displayed based on the pose of the display device 114 and the physical object 106.

The database 302 includes an object dataset 310, and virtual content dataset 312. The object dataset 310 includes features of different physical objects. The virtual content dataset 312 includes virtual content associated with physical objects.

FIG. 4 is a flow diagram illustrating a method for generating and displaying formatted text content, in accordance with an example embodiment. Operations in the routine 400 may be performed by the processor 208, using components (e.g., application, modules, engines) described above with respect to FIG. 2. Accordingly, the routine 400 is described by way of example with reference to the AR/VR application 210 and the immersive reading application 212. However, it shall be appreciated that at least some of the operations of the routine 400 may be deployed on various other hardware configurations or be performed by similar components residing elsewhere.

In block 402, routine 400 accesses an image generated with an image sensor of a device. In block 404, routine 400 detects text content in the image. In block 406, routine 400 accesses a reading preference of the device. In block 408, routine 400 formats the text content according to the reading preference. In block 410, routine 400 generates and displays the formatted text content in a display of the device.

FIG. 5 is a flow diagram illustrating a method for generating and displaying formatted text content, in accordance with another example embodiment. Operations in the routine 500 may be performed by the processor 208, using components (e.g., application, modules, engines) described above with respect to FIG. 2. Accordingly, the routine 500 is described by way of example with reference to the AR/VR application 210 and the immersive reading application 212. However, it shall be appreciated that at least some of the operations of the routine 500 may be deployed on various other hardware configurations or be performed by similar components residing elsewhere.

In block 502, routine 500 accesses an image generated with an image sensor of a device. In block 504, routine 500 detects text content in the image. In block 506, routine 500 accesses a reading preference of the device. In block 508, routine 500 formats the text content according to the reading preference. In block 510, routine 500 generates a virtual object corresponding to the formatted text content. In block 512, routine 500 displays the virtual object in the display of the device.

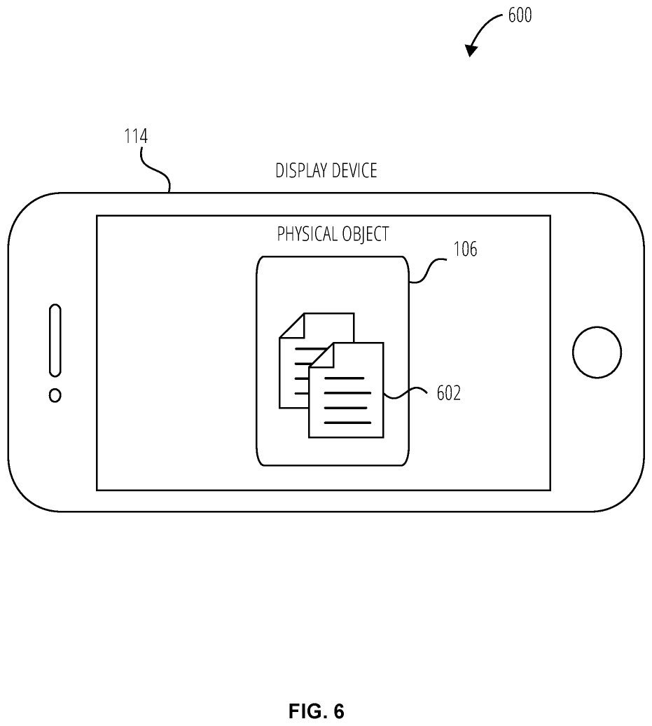

FIG. 6 is an example of a screenshot of a display 204 of the display device 114. The display device 114 displays a (real-time) image of the physical object 106 and the formatted text document 602 (e.g., also referred to as virtual object). For example, the formatted text document 602 is displayed as part of the physical object 106.

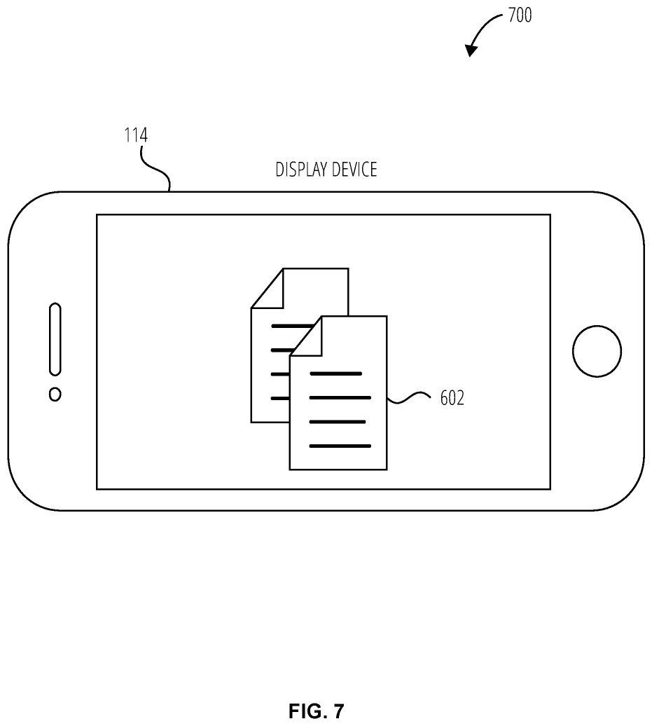

FIG. 7 is an example of a screenshot of a display 204 of the display device 114. The display device 114 displays the formatted text document 602 without the physical object 106. For example, the formatted text document 602 appears to float in the real-world environment 110.

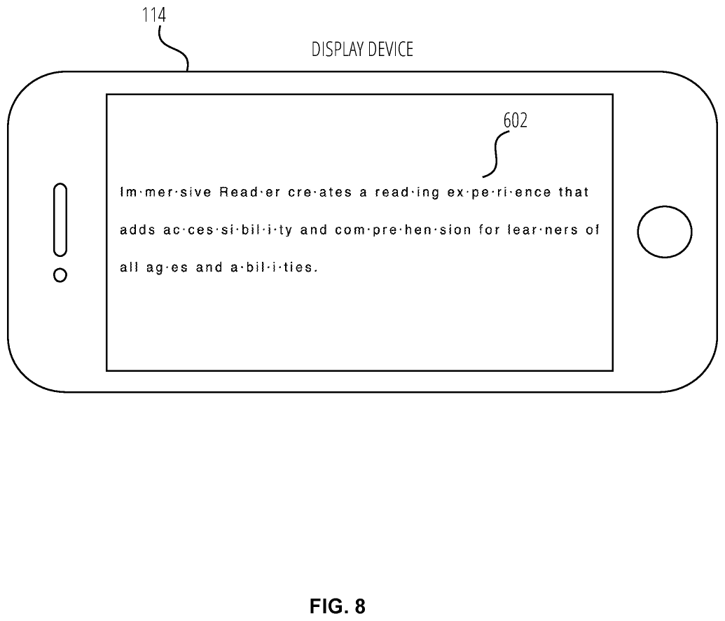

FIG. 8 is an example of the formatted text document 602. The display device 114 only displays the formatted text document 602 without the physical object 106 or any other images captured by the optical sensor 214 of the display device 114.

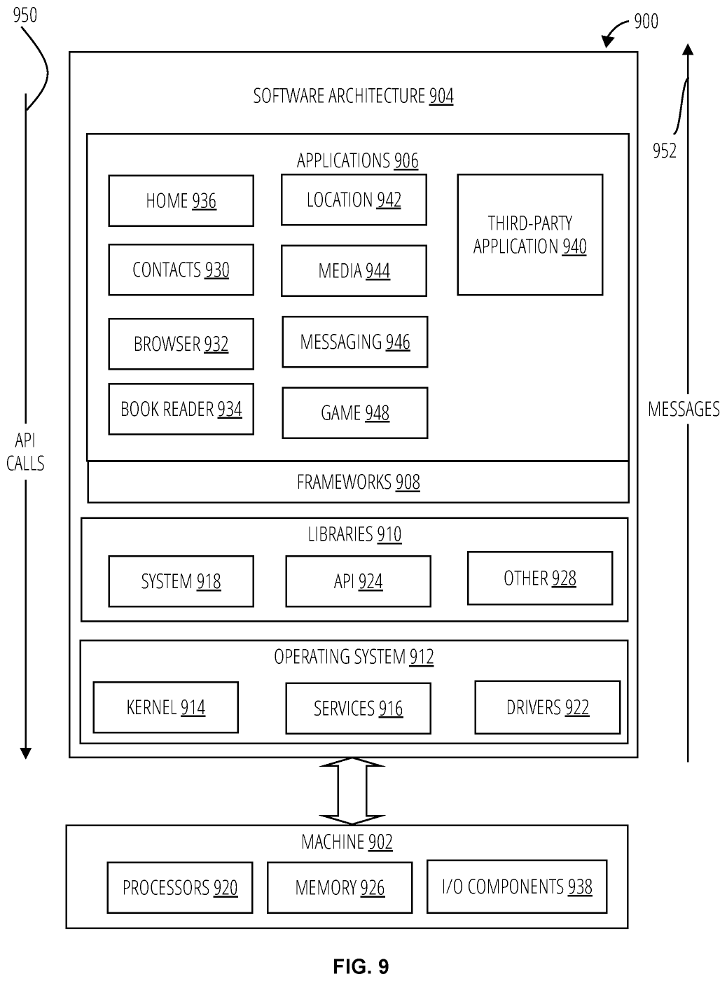

FIG. 9 is a block diagram 900 illustrating a software architecture 904, which can be installed on any one or more of the devices described herein. The software architecture 904 is supported by hardware such as a machine 902 that includes processors 920, memory 926, and I/O components 938. In this example, the software architecture 904 can be conceptualized as a stack of layers, where each layer provides a particular functionality. The software architecture 904 includes layers such as an operating system 912, libraries 910, frameworks 908, and applications 906. Operationally, the applications 906 invoke API calls 950 through the software stack and receive messages 952 in response to the API calls 950.

The operating system 912 manages hardware resources and provides common services. The operating system 912 includes, for example, a kernel 914, services 916, and drivers 922. The kernel 914 acts as an abstraction layer between the hardware and the other software layers. For example, the kernel 914 provides memory management, processor management (e.g., scheduling), component management, networking, and security settings, among other functionality. The services 916 can provide other common services for the other software layers. The drivers 922 are responsible for controlling or interfacing with the underlying hardware. For instance, the drivers 922 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 910 provide a low-level common infrastructure used by the applications 906. The libraries 910 can include system libraries 918 (e.g., C standard library) that provide functions such as memory allocation functions, string manipulation functions, mathematic functions, and the like. In addition, the libraries 910 can include API libraries 924 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 910 can also include a wide variety of other libraries 928 to provide many other APIs to the applications 906.

The frameworks 908 provide a high-level common infrastructure that is used by the applications 906. For example, the frameworks 908 provide various graphical user interface (GUI) functions, high-level resource management, and high-level location services. The frameworks 908 can provide a broad spectrum of other APIs that can be used by the applications 906, some of which may be specific to a particular operating system or platform.

In an example embodiment, the applications 906 may include a home application 936, a contacts application 930, a browser application 932, a book reader application 934, a location application 942, a media application 944, a messaging application 946, a game application 948, and a broad assortment of other applications such as a third-party application 940. The applications 906 are programs that execute functions defined in the programs. Various programming languages can be employed to create one or more of the applications 906, structured in a variety of manners, such as object-oriented programming languages (e.g., Objective-C, Java, or C++) or procedural programming languages (e.g., C or assembly language). In a specific example, the third-party application 940 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 950 provided by the operating system 912 to facilitate functionality described herein.

FIG. 10 is a diagrammatic representation of the machine 1000 within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute any one or more of the methods described herein. The instructions 1008 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines that individually or jointly execute the instructions 1008 to perform any one or more of the methodologies discussed herein.

The machine 1000 may include processors 1002, memory 1004, and I/O components 1042, which may be configured to communicate with each other via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1006 and a processor 1010 that execute the instructions 1008. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1012, a static memory 1014, and a storage unit 1016, both accessible to the processors 1002 via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones may include a touch input device or other such input mechanisms, while a headless server machine will likely not include such a touch input device. It will be appreciated that the I/O components 1042 may include many other components that are not shown in FIG. 10. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 include acceleration sensor components (e.g., accelerometer), gravitation sensor components, rotation sensor components (e.g., gyroscope), and so forth. The environmental components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 further include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (e.g., memory 1004, main memory 1012, static memory 1014, and/or memory of the processors 1002) and/or storage unit 1016 may store one or more sets of instructions and data structures (e.g., software) embodying or used by any one or more of the methodologies or functions described herein. These instructions (e.g., the instructions 1008), when executed by processors 1002, cause various operations to implement the disclosed embodiments.

The instructions 1008 may be transmitted or received over the network 1020, using a transmission medium, via a network interface device (e.g., a network interface component included in the communication components 1040) and using any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### EXAMPLES

Example 1 is a computer-implemented method. The method comprises: accessing an image generated with an image sensor of a device; detecting text content in the image; accessing a reading preference of the device; formatting the text content according to the reading preference; and generating and displaying the formatted text content in a display of the device.

In example 2, the subject matter of example 1 can optionally include: wherein generating and displaying the formatted text content further comprises: generating a virtual object corresponding to the formatted text content; and displaying the virtual object in the display of the device.

In example 3, the subject matter of example 2 can optionally include: wherein the display is configured to only display the virtual object.

In example 4, the subject matter of example 2 can optionally include: wherein the display is configured to display the virtual object and the image, and to replace the text content with the virtual object in the image.

In example 5, the subject matter of example 1 can optionally include: wherein the image includes a live image from the image sensor.

In example 6, the subject matter of example 1 can optionally include: wherein the reading preference identifies a text display format of the text content.

In example 7, the subject matter of example 6 can optionally include: wherein the text display format comprises at least one of a separating syllables format, a highlighting words format, a word spacing format, and a character spacing format.

In example 8, the subject matter of example 1 can optionally include: wherein the reading preference identifies a text-to-speech preference, wherein generating and display the formatted text content further comprises: performing a text-to-speech operation based on the text content, generating, at the device, an audio signal corresponding to the text-to-speech operation; and highlighting a word in the text content corresponding to the audio signal.

In example 9, the subject matter of example 1 can optionally include: wherein the device is configured to be docked to a head mounted adapter.

In example 10, the subject matter of example 1 can optionally include: generating the text content by performing an optical character recognition process on the image.

1. A computer-implemented method comprising:
accessing an image generated with an image sensor of a device;
detecting text content in the image;
accessing a reading preference of the device;
formatting the text content according to the reading preference; and
generating and displaying the formatted text content in a display of the device without displaying the image in the display of the device.

2. The method of claim 1, wherein generating and displaying the formatted text content further comprises:
generating a virtual object corresponding to the formatted text content; and
displaying the virtual object in the display of the device.

3. The method of claim 2, wherein the display is configured to only display the virtual object.

4. The method of claim 2, wherein the display is configured to display the virtual object and the image, and to replace the text content with the virtual object in the image.

5. The method of claim 1, wherein the image includes a live image from the image sensor.

6. The method of claim 1, wherein the reading preference identifies a text display format of the text content.

7. The method of claim 6, wherein the text display format comprises at least one of a word spacing format, or a character spacing format.

8. The method of claim 1, wherein the reading preference identifies a text-to-speech preference,
wherein generating and display the formatted text content further comprises:
performing a text-to-speech operation based on the text content;
generating, at the device, an audio signal corresponding to the text-to-speech operation; and
highlighting a word in the text content corresponding to the audio signal.

9. The method of claim 1, wherein the device is configured to be docked to a head mounted adapter.

10. The method of claim 1, wherein detecting the text content further comprises:
generating the text content by performing an optical character recognition process on the image.

11. A computing apparatus, the computing apparatus comprising:
a processor; and
a memory storing instructions that, when executed by the processor, configure the apparatus to perform operations comprising:
access an image generated with an image sensor of a device;
detect text content in the image;
access a reading preference of the device;
format the text content according to the reading preference; and
generate and display the formatted text content in a display of the device without displaying the image in the display of the device.

12. The computing apparatus of claim 11, wherein generating and display the formatted text content further comprises:
generate a virtual object corresponding to the formatted text content; and
display the virtual object in the display of the device.

13. The computing apparatus of claim 12, wherein the display is configured to only display the virtual object.

14. The computing apparatus of claim 12, wherein the display is configured to display the virtual object and the image, and to replace the text content with the virtual object in the image.

15. The computing apparatus of claim 11, wherein the image includes a live image from the image sensor.

16. The computing apparatus of claim 11, wherein the reading preference identifies a text display format of the text content.

17. The computing apparatus of claim 16, wherein the text display format comprises at least one of a word space format, or a character spacing format.

18. The computing apparatus of claim 11, wherein the reading preference identifies a text-to-speech preference,
wherein generating and display the formatted text content further comprises:
perform a text-to-speech operation based on the text content;
generate, at the device, an audio signal corresponding to the text-to-speech operation; and
highlight a word in the text content corresponding to the audio signal.

19. The computing apparatus of claim 11, wherein the device is configured to be docked to a head mounted adapter.

20. A non-transitory computer-readable storage medium, the computer-readable storage medium including instructions that when executed by a computer, cause the computer to:
access an image generated with an image sensor of a device;
detect text content in the image;
access a reading preference of the device;
format the text content according to the reading preference; and
generate and display the formatted text content in a display of the device without displaying the image in the display of the device.
